(19) United States
(12) Patent Application Publication
(10) Pub. No.: US 2025/0267479 A1
(43) Pub. Date: Aug. 21, 2025

(54) UE REPORTING FOR INTER-RAT MEASUREMENTS WITHOUT GAPS

(71) Applicant: MEDIATEK INC., Hsinchu (TW)

(72) Inventors: Waseem Hazim Ozan Ozan, Cambridge (GB); Tsang-Wei Yu, Hsinchu (TW)

(21) Appl. No.: 19/034,801

(22) Filed: Jan. 23, 2025

Related U.S. Application Data
(60) Provisional application No. 63/560,808, filed on Mar. 4, 2024.
(60) Provisional application No. 63/555,137, filed on Feb. 19, 2024.

(51) Int. Cl. H04W 24/02; H04L 27/26; H04W 8/22; H04W 24/10

(52) U.S. Cl. CPC H04W 24/02; H04L 27/26025; H04W 8/22; H04W 24/10

(57) ABSTRACT

In an aspect of the disclosure, a method, a computer-readable medium, and an apparatus are provided. The method may be performed by a UE. The UE receives, from a network (NW), a configuration for inter-radio access technology (RAT) measurement without a gap for a frequency band. The UE identifies a UE capability for supporting the configuration. The UE determines a UE behavior associated with scheduling restriction based on the UE capability. The UE performs the UE behavior.

### CROSS-REFERENCE TO RELATED APPLICATION(S)

This application claims the benefits of U.S. Provisional Application Ser. No. 63/555,137, entitled “UE REPORTING FOR INTER-RAT MEASUREMENTS WITHOUT GAPS” and filed on Feb. 19, 2024 and U.S. Provisional Application Ser. No. 63/560,808, entitled “UE REPORTING FOR INTER-RAT MEASUREMENTS WITHOUT GAPS AND UE CAN'T DETERMINE THE NEED FOR SCHEDULING RESTRICTIONS” and filed on Mar. 4, 2024, both of which are expressly incorporated by reference herein in their entirety.

### BACKGROUND

### Field

The present disclosure relates generally to wireless communications, and more particularly, to techniques of User Equipment (UE) reporting for inter-Radio Access Technology (RAT) measurements without gaps where the UE cannot determine the need for scheduling restrictions.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The method may be performed by a UE. The UE receives, from a network (NW), a configuration for inter-radio access technology (RAT) measurement without a gap for a frequency band. The UE identifies a UE capability for supporting the configuration. The UE determines a UE behavior associated with scheduling restriction based on the UE capability. The UE performs the UE behavior.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIGS. 7 (A) and 7 (B) are diagrams illustrating example configurations using measurement gaps.

FIGS. 8 (A) and 8 (B) are diagrams illustrating example configurations using interruptions.

FIG. 9 illustrates a flow chart of a process for UE reporting.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

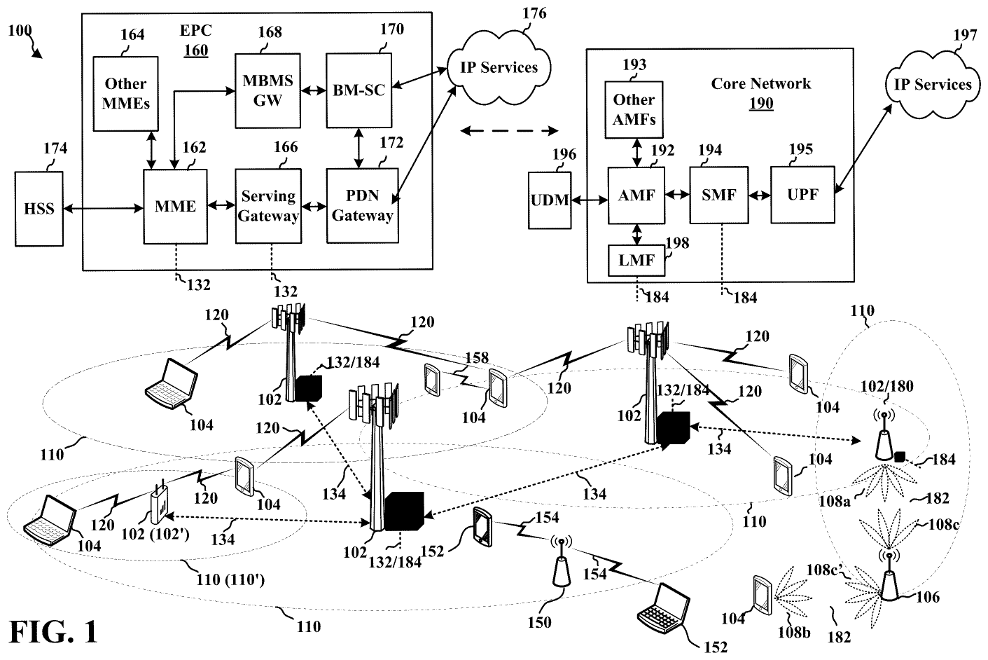

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information. The core network 190 may include an Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

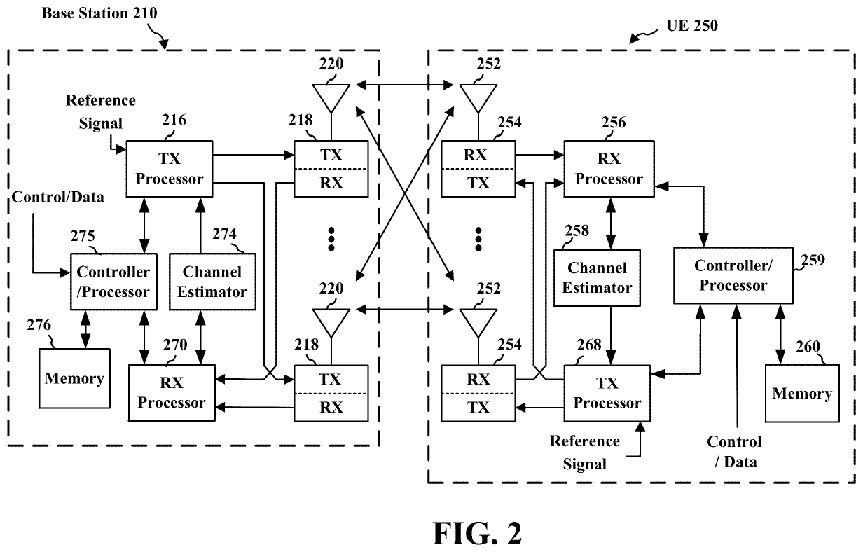

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHZ), massive MTC (mMTC) targeting non-backward compatible MTC techniques, and/or mission critical targeting ultra-reliable low latency communications (URLLC) service.

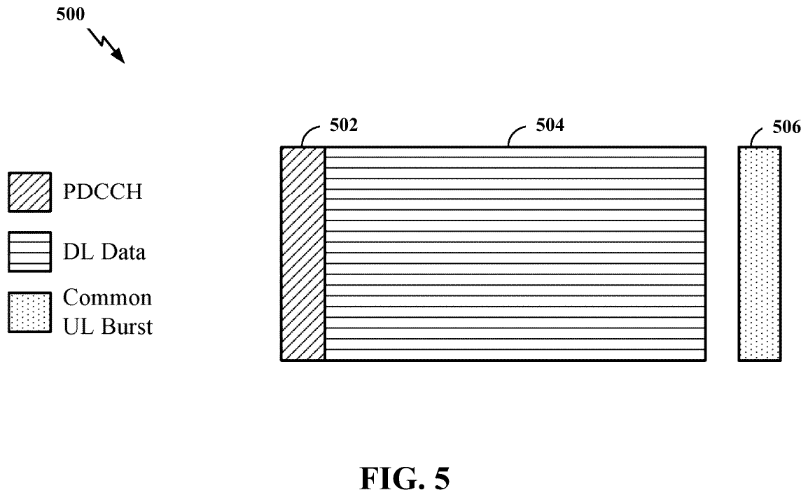

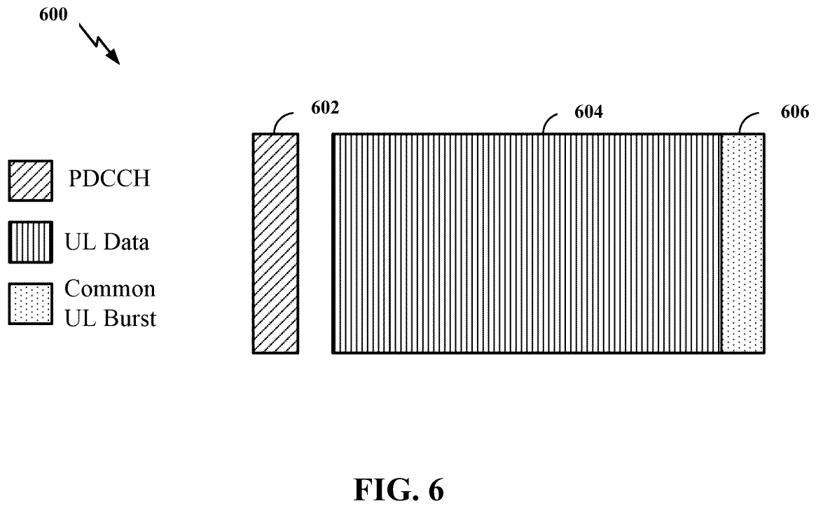

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases, DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

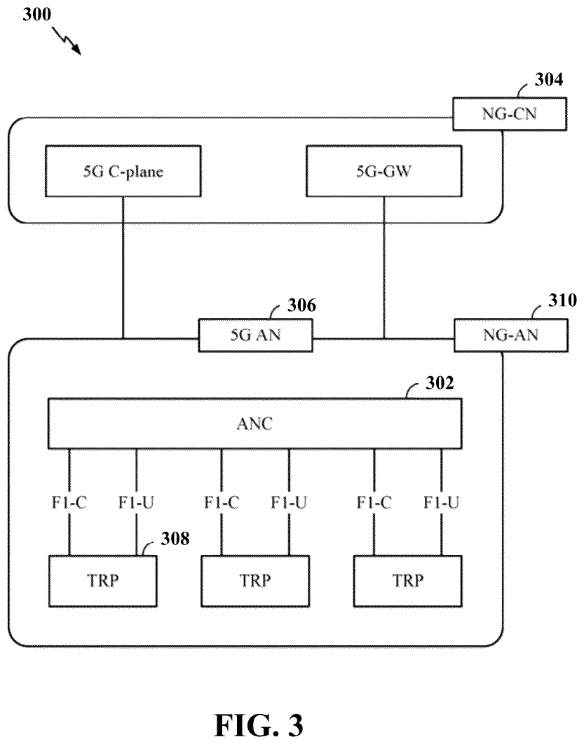

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

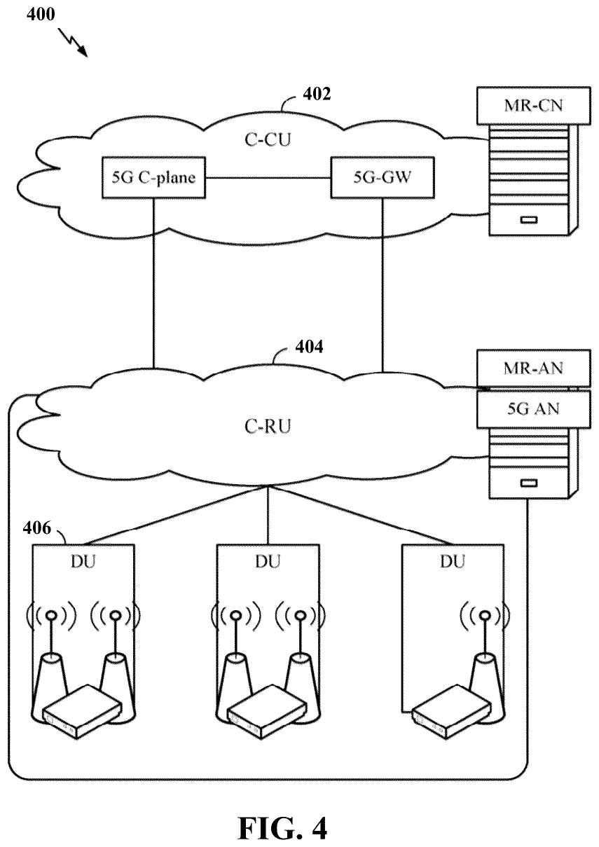

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

A wireless device may perform measurements on one or more downlink (DL) and/or uplink (UL) reference signal (RS) of one or more cells in different wireless device activity states e.g., radio resource control (RRC) idle state, RRC inactive state, RRC connected state, etc. The measured cell may belong to or operate on the same carrier frequency as of the serving cell (e.g., intra-frequency carrier) or it may belong to or operate on different carrier frequency as of the serving cell (e.g., non-serving carrier frequency). The non-serving carrier may be referred to as inter-frequency carrier if the serving and measured cells belong to the same radio access technology (RAT) but different carriers. The non-serving carrier may be referred to as inter-RAT carrier if the serving and measured cells belong to different RATs. Examples of downlink RS are signals in synchronization signal block (SSB), channel state information RS (CSLRS), Cell-specific Reference Signal (CRS), demodulation reference signal (DMRS), primary synchronization signal (PSS), secondary synchronization signal (SSS), signals in synchronization signal/physical broadcast channel (SS/PBCH) block (SSB), discovery reference signal (DRS), positioning reference signal (PRS), etc. Examples of uplink RS are signals in sounding reference signal (SRS), DMRS etc.

Each SSB carries NR-PSS, NR-SSS and NR-PBCH in 4 successive symbols. One or multiple SSBs are transmitted in one SSB burst which is repeated with certain periodicity, e.g., 5 ms, 10 ms, 20 ms, 40 ms, 80 ms and 160 ms. The wireless device is configured with information about SSB on cells of certain carrier frequency by one or more SS/PBCH block measurement timing configuration (SMTC) configurations. The SMTC configuration including parameters such as SMTC periodicity, SMTC occasion length in time or duration, SMTC time offset with reference to the reference time (e.g., serving cell's SFN) etc. Therefore, SMTC occasion may also occur with certain periodicity, e.g., 5 ms, 10 ms, 20 ms, 40 ms, 80 ms and 160 ms.

The measurements may be performed for various purposes. Some example measurement purposes are: wireless device mobility (e.g., cell change, cell selection, cell reselection, handover, RRC connection re-establishment, etc.), wireless device positioning or location determination self-organizing network (SON), minimization of drive tests (MDT), operation and maintenance (O&M), network planning and optimization etc. In some embodiments, the measurements may include cell identification (e.g., PCI acquisition, PSS/SSS detection, cell detection, cell search, etc.), Reference Symbol Received Power (RSRP), Reference Symbol Received Quality (RSRQ), secondary synchronization RSRP (SS-RSRP), SS-RSRQ, SINR, RS-SINR, SS-SINR, CSI-RSRP, CSI-RSRQ, received signal strength indicator (RSSI), acquisition of system information (SI), cell global ID (CGI) acquisition, Reference Signal Time Difference (RSTD), UE RX-TX time difference measurement, Radio Link Monitoring (RLM), which consists of Out of Synchronization (out of sync) detection and In Synchronization (in-sync) detection, etc.

The wireless device may be typically configured by the network (e.g., via RRC message) with measurement configuration and measurement reporting configuration, e.g., measurement gap pattern (MGP), carrier frequency information, types of measurements (e.g., RSRP etc.), higher layer filtering coefficient, time to trigger report, reporting mechanism (e.g., periodic, event triggered reporting, event triggered periodic reporting etc.), etc. The measurement gap patterns may be characterized by a measurement gap length (MGL), a measurement gap repetition period (MGRP), a measurement gap offset (MGO) relating the measurement gap, e.g., to the frame border of system frame number (SFN) 0, and a measurement gap timing advance (MGTA) which may shift the position of the measurement gap by 0, 0.25 or 0.5 ms relative to the measurement gap starting point given by MGO. The wireless device-based signaling procedure may allow for “no gaps” to be configured for certain bands. For example, “gap” or “no-gap” could be indicated/reported by the wireless device, according to the information that a network/network node has already provided in a RRCReconfiguration message.

In NR, inter-RAT measurements may be defined for NR-E-UTRAN FDD and NR-E-UTRAN TDD measurements and may be applicable without an explicit E-UTRAN neighbor cell list containing physical layer cell identities, for a wireless device in RRC CONNECTED state. The inter-RAT measurements may be performed in a measurement gap or Network Controlled Small Gap (NCSG) (hereinafter referred to collectively as “gap”). The NCSG is actually a short interruption. The wireless device may require measurement gaps or NCSG to identify and measure inter-RAT cells. Measurement gap pattern (MGP) may be used by the wireless device for performing measurements on cells of the non-serving carriers (e.g., inter-frequency carrier, inter-RAT carriers etc.). In NR, gaps may also be used for measurements on cells of the serving carrier in some scenarios, e.g., if the measured signals (e.g., SSB) are outside the bandwidth part (BWP) of the serving cell. The wireless device is scheduled in the serving cell only within the BWP. During the gap, the wireless device cannot be scheduled for receiving/transmitting signals in the serving cell. A measurement gap pattern is characterized or defined by several parameters: measurement gap length (MGL), measurement gap repetition period (MGRP) and measurement gap time offset with respect to reference time (e.g., slot offset with respect to serving cell's SFN such as SFN=0).

The measurement gap configuration may be provided by the network 100 to the UE 104 via the serving cell or base station 102. The UE 104 may indicate to the network 100 the radio-frequency (RF) capability and the band capability of the UE 104 so that the network 110 can configure cell-group specific measurement for carrier aggregation (CA) or dual connectivity (DC) to reduce measurement delay and/or increase the downlink date rate if the UE 104 has two or more RF chains and is capable of operating on multiple frequency bands for the two or more RF chains. The UE 104 may include multiple radio-frequency (RF) chains such as RF chain 1 (RF CHAIN 1), RF chain 2 (RF CHAIN 2), up to an Nth RF chain (RF CHAIN N). The RF chains may be coupled to multiple antennas, and the RF chains may be controlled by a processor of the wireless device. One or more of the RF chains may be capable of operating on one or more frequency bands to transmit and/or receive data in the uplink and/or the downlink. since the UE 104 has more than one RF chain, the UE 104 is capable of using both RF chains for gap measurements to reduce measurement delay and/or to increase spectrum efficiency.

In NR, the spectrum is divided into two frequency ranges namely FRI and FR2. FR1 is currently defined from 410 MHz to 7125 MHz. FR2 range is currently defined from 24250 MHz to 71000 MHz. The FR2 range is also interchangeably called as millimeter wave (mmwave) and corresponding bands in FR2 are called as mmwave bands.

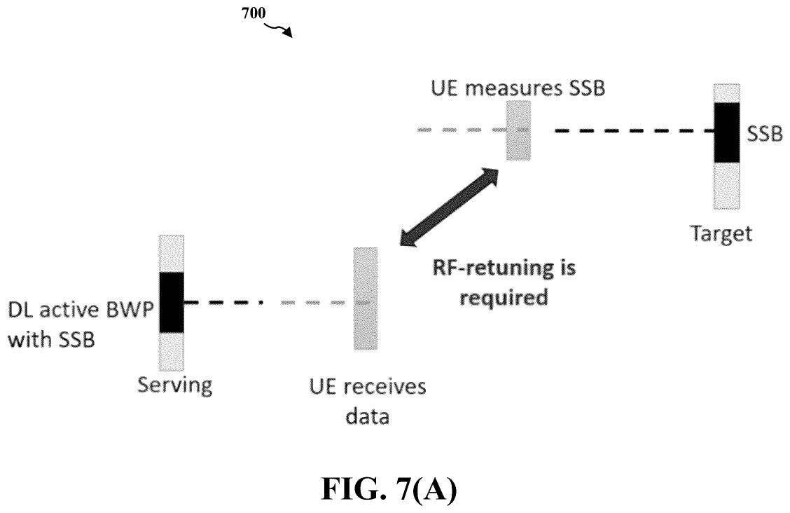

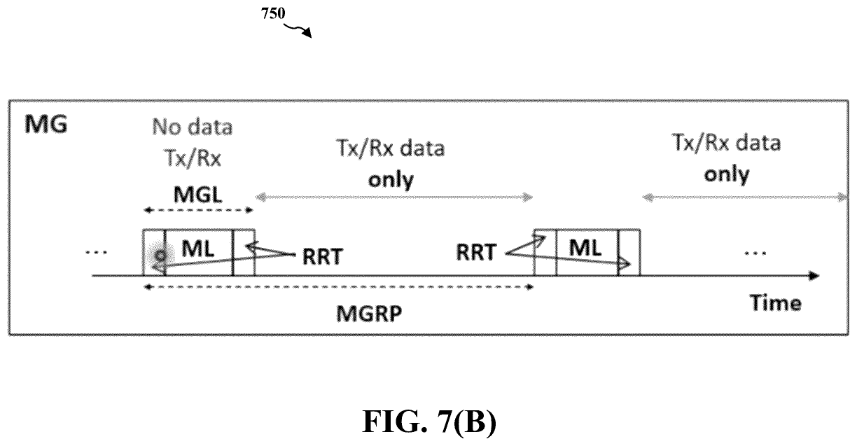

FIGS. 7 (A) and 7(B) are diagrams 700 and 750 illustrating example configurations using measurement gaps. The Measurements gaps are always configured for DL/UL, and typically responsible for 15% (e.g., MGL=6 ms, MGRP=20 ms) interruption of data transmission and reception. As shown in FIG. 7 (B), the MGL includes two RF-retuning time (RRT) and one measurement length (ML) between the two RRTs. For FRI, the RRT may be 0.5 ms, and for FR2, the RRT may be 0.25 ms.

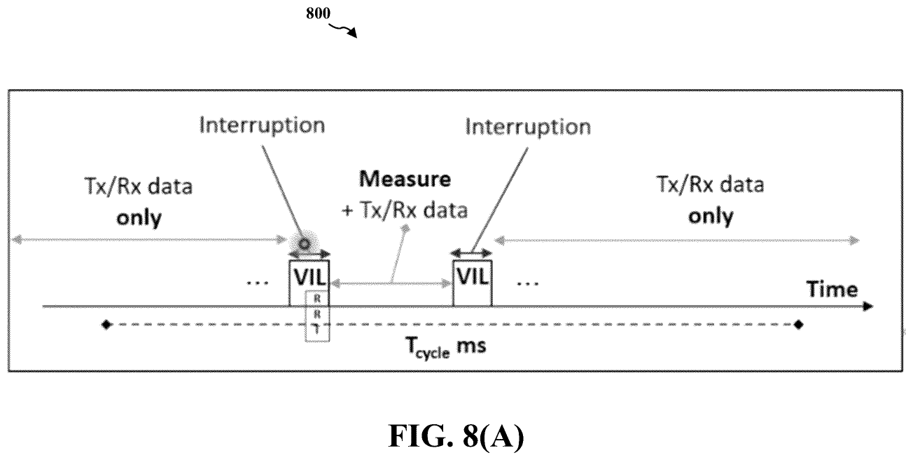

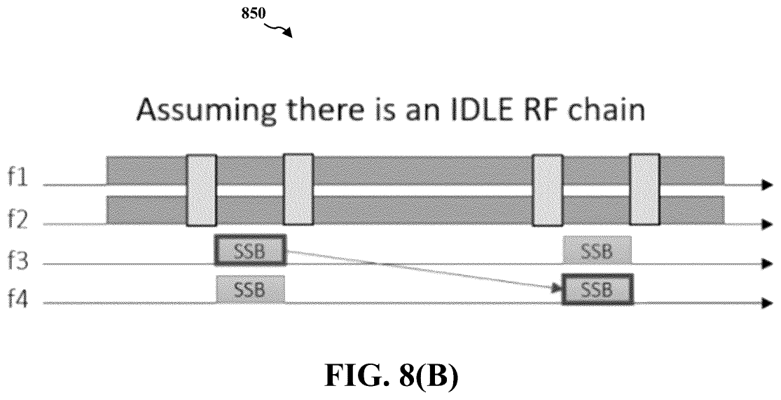

FIGS. 8 (A) and 8 (B) are diagrams 800 and 850 illustrating example configurations using interruptions. When the UE 104 performs measurements with interruptions (e.g., indicated by the blocks on carriers f1 and f2), it does not need gaps but needs interruptions before and after the measurement on all component carriers (CCs). Thus, the UE 104 can simultaneously perform measurement and data reception.

The term component carrier (CC) is also called as carrier frequency, frequency layer, layer, carrier, frequency, serving carrier, frequency channel, positioning frequency layer (PFL) etc. The CC belongs to certain frequency band, which may contain one or multiple carrier frequencies based on its passband (e.g., size of the band in frequency domain) and/or bandwidth of the carriers and/or the channel raster, etc. The CC related information is transmitted to the wireless device by a network node using a channel number or identifier via message, e.g., RRC.

As shown in FIG. 8 (A), for an interruption structure, two visible interruption lengths (VILs) may be needed for each T_{cycle}. For FRI, the RRT may be 0.5 ms, and For FR2, the RRT may be 0.25 ms. The VIL is longer than RRT to accommodate additional UE baseband processing time. For FRI, the VIL may be 0.5 ms, and For FR2, the VIL may be 0.25 ms. As shown in FIG. 8 (B), assuming there is an idle RF chain, when an interruption is expected, RF switch may be required, for example, from the SSB at the carrier f3 to the SSB at the carrier f4.

The NCSG may be configured on serving carrier subframes of a serving, with a visible interruption length VIL1 before the measurement length ML during which there is no gap, and a visible interruption length VIL2 after the measurement length ML. In NCSG configurations, during the VIL1 period and the VIL2 period, a wireless device, such as the UE 104, is not expected to transmit or receive any data. During the ML period, the UE 104 is expected to transmit and/or receive data on the corresponding serving carrier(s), for example, depending on a scheduling restriction.

As mentioned earlier, during the gap, the wireless device cannot be scheduled for receiving/transmitting signals in the serving cell. That is, the gap is a complete restriction. In contrast to the gap, the scheduling restriction is a partial restriction. The scheduling restriction is used in the scenarios in which the wireless device can perform measurement without gaps in NR. The scheduling restriction occurs whenever there is no gap. For example, it is a restriction configured by the network side to prevent scheduling of any data during the two symbols immediately before and after the SMTC occasion, in order to avoid interruptions.

Examples of such measurements may be SSB based intra-frequency or inter-frequency measurements without measurement gaps when the reference signals (e.g., SSB) used for measurements are fully within the bandwidth of the active BWP of the wireless device. In another example, intra-frequency, inter-frequency or inter-RAT measurements can be performed without gaps if the wireless device has an extra or spare receiver chain which in turn can be used for measurements. However, during the resources containing the reference signals (e.g., SSB, CSLRS, etc.) used for measurements, there can be scheduling restrictions. The scheduling restriction implies that at least during the resources containing the reference signals used for measurements as well X1 number of symbols before and X2 number of symbols after these measurement reference signals, the wireless device may be not expected to transmit or receive any signal in the serving cell based on some specific conditions. For example, the received data and measured SSB are mix numerology in FRI or received data and measured SSB are intra-frequency or inter-frequency with common beam management (CBM) in FR2.

In general, when a scheduling restriction is applied to a signal in one or more time resources (e.g., symbol, slot, etc.), the wireless device is not expected or is not required to operate (e.g., transmit and/or receive) that signal in those time resources (e.g., may be called as restricted time resources). Examples of such signals are control channel (e.g., PDCCH, PUCCH), data channel (e.g., PDSCH, PUSCH), reference signal (e.g., CRS, SSB, PSSS, SSS, PRS SRS, TRS, CSI-RS etc.), measurement reports (e.g., CSI reports, CQI report), feedback signals (e.g., ACK, NACK messages), etc. During the restricted time resources, the wireless device is not scheduled with the signals for which the scheduling restriction is defined, e.g., as a rule, which can be pre-defined or configured by a network node, such as the base station 102.

In NR, the scheduling restriction may be defined for a measurement without gap, such as intra-frequency measurement without gap, inter-frequency measurement without gap, and inter-frequency measurement with NCSG etc. Possible related scheduling restriction include UE performing measurements in TDD bands or with different SCS for inter-RAT E-UTRAN measurement without gap. For example, a UE receiving NR data with SCS=30 KHz and performing Inter-RAT E-UTRAN measurement can be a typical scenario to be consider.

A benefit of introducing the scheduling restriction is that the network can schedule the data outside the symbols to-be-measured. In NR, the to-be-measured symbols are SSB symbols or CSI-RS symbols. The question is how to apply the scheduling restriction for E-UTRAN measurement. The E-UTRAN measurement is based on CRS/PSS/SSS other than SSB symbols and the measurement can be performed in any CRS without restriction.

A configuration for inter-RAT measurement without measurement gaps may define an effective measurement window (EMW) for performing inter-RAT measurement without measurement gaps. The EMW may be based on at least one of: a configured measurement gap pattern; a configured reference signal configuration; a predefined configuration defining a periodicity and offset of the EMW; information signaled in radio resource control, RRC, signaling; and a number of carriers configured for performing measurements without gaps. The wireless device may indicate that it supports inter-RAT measurement (e.g., inter-RAT E-UTRAN measurement) without gap with respect to corresponding capability indicated. By introducing the EMW, both NW and UE may have the common understanding on the occasions for the measurements and scheduling restriction.

When both wireless device such as the UE 104 and network node such as the base station 102 support inter-RAT measurement without gap, and the bandwidth (BW) of the target cell's RS for inter-RAT carrier frequency (e.g., CRS BW for E-UTRAN frequency layer) are fully within the BW of the active BWP of serving NR cell, then the UE 104 may perform inter-RAT measurement without gap for these inter-RAT carriers (e.g. E-UTRAN frequency layers).

In 5G NR, when the wireless device, such as the UE 104, performs inter-RAT E-UTRAN measurements, it may conduct these measurements within NCSG occasions. Furthermore, the UE 104 performs measurements during NCSG occasions regardless of whether it requires scheduling restrictions/availability (short interruptions as specified in 3GPP standard such as in, for example, 3GPP TS 38.133).

For inter-RAT E-UTRAN measurements that are conducted without gaps and interruptions, the UE 104 may or may not need scheduling restrictions/availability. Therefore, there should be common agreement between the UE 104 and the NW (e.g., network 100 via the base station 102) to align the UE's behavior and reporting with the NW configuration and scheduling.

Furthermore, if the UE 104 cannot determine whether the scheduling restriction is needed or if it requires scheduling restrictions but cannot support EMW, this situation should be appropriately handled.

To address the above issues, the UE 104 shall determine whether the scheduling restriction is needed or not. The UE 104 can perform inter-RAT E-UTRAN measurements by using the measurement gap. However, if there is no gap, it has another opportunity to perform these measurements-specifically, by relying on interruptions. Furthermore, if interruptions are also absent, there is still a chance to conduct the measurements, namely, through scheduling restrictions.

The gap allows the UE 104 to switch off one of its RF chains to perform RF retuning and measurements. The reason for this is that if the UE 104 does not have enough RF chains available, it needs to deactivate one to make space. Hence, the UE 104 requires a gap.

Currently, it is assumed that to activate this feature without gaps or interruptions, the UE 104 should have one or two idle modes or idle RF chains. When an RF chain is idle, it can be utilized for measurement purposes, for example, as shown in FIG. 8 (B).

For example, when the UE 104 can perform inter-RAT E-UTRAN measurements without gaps and interruptions for a specific frequency band, it shall determine whether scheduling restrictions are necessary based on at least one of its currently configured CA band combination or the target inter-RAT E-UTRAN band that needs to be measured.

The approach essentially defines that the wireless device such as the UE 104 should generally determine whether scheduling restrictions are needed. It proposes that when the UE 104 supports measurements without gaps and interruptions, it still assesses whether scheduling restrictions are required.

In some embodiments, if the UE 104 requires scheduling restrictions but does not support the EMW capability, it shall report at least one of NCSG or gaps.

The reason implementing these embodiments may be that, despite not requiring a gap or interruption, the UE 104 imposes scheduling restrictions. Consequently, these restrictions need to be limited. Therefore, it is preferable for the UE 104 to refrain from applying scheduling restrictions universally and instead restrict them within the EMW. That is, the EMW is to lower the number of occasions where the UE 104 should measure.

When the UE 104 requires scheduling restriction but does not support the EMW function to restrict the scheduling restriction, the UE 104 may report either at least one of NCSG or a gap. In other words, the UE 104 will revert to its legacy behavior. The UE 104 should not report measurements without gaps and without interruptions.

If the UE 104 supports EMW and indicates a need for it, that is, the UE 104 informs the NW of its requirement for EMW capability, the NW recognizes that the UE 104 requires scheduling restriction. The UE 104 will cause scheduling restriction within the EMW, or the NW will not schedule data during the scheduling restriction symbols. However, if the UE 104 cannot support EMW but still needs scheduling restriction, the UE 104 will report at least one of NCSG or a gap. Consequently, the UE 104 will not cause scheduling restriction outside the context of EMW. In other words, if the UE 104 cannot support EMW, the UE 104 is not allowed to do any scheduling restriction. Furthermore, if the UE 104 still needs scheduling restriction, the UE 104 should report either at least one of NCSG or a gap.

Additionally, or alternatively, in some embodiments, if the UE 104 cannot guarantee the absence of scheduling restrictions, or cannot determine whether scheduling restrictions are needed but can support the EMW capability, then it shall report its support for the EMW for inter-RAT E-UTRAN measurements without gaps and with or without interruptions.

As mentioned earlier, the advantage of EMW is to limit the scheduling restriction. It needs to support inter-RAT E-UTRAN measurement without gaps, with or without interruption. These features need to be prerequisites. The support configuration of the EMW for inter-RAT E-UTRAN measurement may include offset, duration, and periodicity.

In some cases, during the inter-RAT E-UTRAN measurements within the EMW, the UE 104 may or may not cause scheduling restrictions. In other words, even though the UE 104 has reported EMW, it is not mandatory for the UE 104 to actually have EMW scheduling restriction around the SSB. It depends on the UE's implementation. The issue is that the UE 104 may not be able to determine whether scheduling restriction is needed or not. Therefore, the UE 104 may still report EMW, but this does not necessarily mean that it will actually use the scheduling restriction.

In other cases, the NW may determine whether the UE 104 requires scheduling restrictions based on the fulfillment of one or more of the following conditions:

Condition 1: The UE 104 can be scheduled to perform inter-RAT E-UTRAN measurements with a subcarrier spacing than PDSCH/PDCCH on FRI, but the UE 104 does not support simultaneous reception with different subcarrier spacings. Condition 1 involves scheduling availability for UE performing inter-RAT E-UTRAN measurement with a different subcarrier spacing.

Condition 2: Whether the UE 104 supports the DC configuration information element simultaneousRxTxInterBandENDC for a band combination involving the band with UE's serving cells and the target band to be measured. Regarding the feature “simultaneousRxTxInterBandENDC”, if the UE 104 supports this feature, then the UE does not need a scheduling restriction. If the UE 104 cannot support this feature, then the UE needs scheduling restriction.

That is, if UE cannot determine the need of scheduling restrictions, the NW can determine whether the scheduling restriction is needed or not. These conditions assist the NW in determining for the UE 104.

From a high-level perspective, when scheduling restriction is needed for a UE, such as the UE 104, it indicates that the UE 104 cannot perform measurements with all the other activities. Therefore, certain restrictions are necessary to allow the UE to conduct measurements.

The restriction is around the SSB and is confined to a specific CC. Imagine a scenario with multiple CCs, where the UE 104 is performing measurements on one of them. Essentially, there is ongoing measurement activity focused on the SSB part within the SMTC.

For example, when subcarrier spacing varies, there is a baseband limitation related to changing the Fast Fourier Transform (FFT). The FFT differs for different subcarrier spacings. This is one of the reasons why scheduling restrictions are required.

In additional embodiments, the approach is applicable to the scenario of inter-RAT E-UTRAN measurements without gaps, and any reference signals are located outside the active Downlink Bandwidth Part (DL BWP). The approach is also applicable to the scenario of inter-RAT E-UTRAN measurements without gaps when the CRS is contained within the UE's active DL BWP. That is, the first scenario is when the reference signals are outside the active bandwidth part. The second scenario is when the CRS is within the active bandwidth part.

In summary, in NR, regarding E-UTRAN measurements without measurement gaps, the general requirements include:
(1) If an NR-E-UTRAN measurement does not cause scheduling restriction, the measurement is performed outside measurement gaps.
(2) If an NR-E-UTRAN measurement causes scheduling restriction, the measurement is performed within measurement gaps if one of the following conditions is met:
   EMW is configured and fully overlapped with measurement gap, and the periodicity of measurement gap and EMW is same, or
   EMW is not configured.
Otherwise, the measurement is performed within EMW occasions.

When UE is configured with EMW and measurement gap, EMW and measurement gap occasions are considered colliding if the two occasions are fully or partially overlapping in time domain.

Regarding scheduling availability during NR-E-UTRAN FDD measurements, when certain conditions are met, there are restrictions on the scheduling availability; otherwise, there is no scheduling restriction.

For example, regarding scheduling availability of UE during intra-frequency measurements without measurement gap, when the UE performs intra-frequency measurement TDD band, there may be some restrictions applied. For TDD, the restriction only happens at the uplink side, Therefore, in this case, the UE is not expected to transmit on SSB symbols to be measured and one data symbol before each consecutive SSB symbol (i.e., uplink restriction).

In another aspect, regarding scheduling availability of UE performing inter-RAT measurements with a different subcarrier spacing than PDSCH/PDCCH on FRI, when the UE performs inter-RAT measurement outside MG and the E-UTRA carrier is fully or partially overlapping with the DL active BWP of the serving cell, for UE which do not support concurrent inter-RAT measurement on E-UTRAN cell in non-DSS with CRS and PDCCH or PDSCH reception from the serving cell with a different numerology, the following restrictions apply due to RSRP/RSRQ/SINR measurement: the UE is not expected to transmit PUCCH/PUSCH/SRS or receive PDCCH/PDSCH/TRS/CSI-RS for CQI on all symbols within EMW duration.

In other words, when there is a different subcarrier spacing, the restriction is on both uplink and downlink, this is because different FFT size is needed. In this scenario, the UE is not expected to transmit or receive the following on SSB symbol to be measured, that is, one data symbol before each consecutive SSB, and one after each consecutive SSB. However, in contrast to the uplink restriction scenario, the number of symbols is the same. There are similar scheduling restriction on FR2. In summary, this scenario may also be called scheduling availability of inter-frequency measurements without a gap.

That is, in a given scenario, both the UE and the NW would be aware of what kind of restrictions need to be applied. If the NW recognizes that the UE does not require any scheduling restrictions, it can proceed to schedule data for the UE. Consequently, scheduling is typically viewed from the perspective of the NW, as it has the authority to either schedule or not schedule data for the UE.

Regarding scheduling availability during NR-E-UTRAN TDD measurements, when certain conditions are met, there are restrictions on the scheduling availability; otherwise, there is no scheduling restriction.

For example, regarding scheduling availability of UE performing inter-RAT measurements in TDD bands on FRI, the scheduling restriction will be applied to the whole EMW or with the symbols level.

When the UE performs inter-RAT measurements in a TDD band outside MG and the E-UTRA carrier is within DL active BWP of the serving cell, the following restrictions apply on the NR serving cell due to RSRP, RS-SINR and RSRQ measurement: the UE is not expected to transmit PUCCH/PUSCH/SRS on all symbols within EMW duration.

When the UE performs inter-RAT measurement in a TDD band outside MG and the E-UTRA carrier is outside DL active BWP of the serving cell, the following restrictions apply on the NR serving cell due to RSRP/RSRQ/SINR measurement, when the NR serving cell and E-URTA carrier are in a band pair for which UE does not have the capability of supporting simultaneousRxTxInterBandCA: the UE is not expected to transmit PUCCH/PUSCH/SRS on all symbols within EMW duration.

Regarding schedule availability of UE performing inter-RAT measurements with a different subcarrier spacing than PDSCH/PDCCH on FRI, when UE performs inter-RAT measurement outside MG and the E-UTRA carrier is fully or partially overlapping with the DL active BWP of the serving cell, for UE which do not support concurrent inter-RAT measurement on E-UTRAN cell in non-DSS with CRS and PDCCH or PDSCH reception from the serving cell with a different numerology, the following restrictions apply due to RSRP/RSRQ/SINR measurement: the UE is not expected to transmit PUCCH/PUSCH/SRS or receive PDCCH/PDSCH/TRS/CSI-RS for CQI on all symbols within EMW duration.

The present disclosure involves the UE behaviors for inter-RAT measurements without gaps where the UE cannot determine the need for scheduling restrictions. Currently, there is a lack of defined UE behaviors in this scenario, which may degrade the NR performance, e.g., user throughput loss, reduction in the user bit rate, etc. The present disclosure proposes an approach to handle this issue. For clearly defining the UE behaviors for inter-RAT measurements, the proposed approach enhances the NR performance.

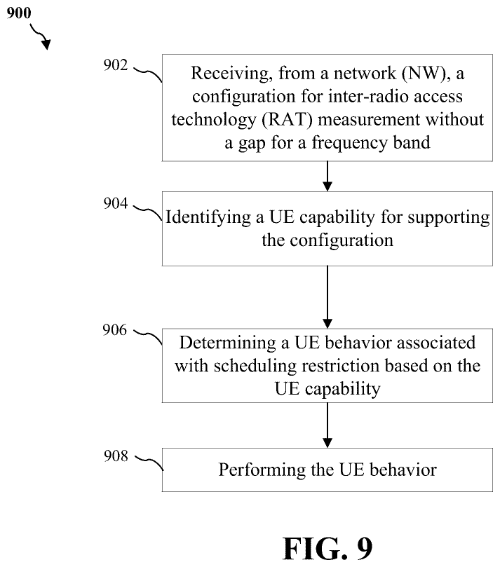

FIG. 9 illustrates a flow chart 900 of a process for UE reporting. The process may be performed by a UE (e.g., the UE 104). In operation 902, the UE receives, from a network (NW), a configuration for inter-radio access technology (RAT) measurement without a gap for a frequency band. In certain configurations, the inter-RAT measurement may include inter-RAT evolved universal terrestrial radio access network (E-UTRAN) measurement.

In operation 904, the UE identifies a UE capability for supporting the configuration. Subsequently, in operation 906, the UE determines a UE behavior associated with scheduling restriction based on the UE capability. An example of determining the UE behavior associated with the scheduling restriction may include: determining necessity of the scheduling restriction. In certain configurations, determining the necessity of the scheduling restriction may be based on currently configured carrier aggregation (CA) band combination. Alternatively, determining the necessity of the scheduling restriction may be based on a target inter-RAT E-UTRAN band to be measured.

In operation 908, the UE performs the UE behavior. In certain configurations, performing the UE behavior may include: reporting at least one of a network controlled small gap (NCSG) or a measurement gap, when the UE requires the scheduling restriction and the UE capability does not support an effective measurement window (EMW).

In certain configurations, performing the UE behavior may include: reporting the UE capability supporting an effective measurement window (EMW), when the UE is unable to ensure absence of the scheduling restriction; and the EMW is configured for inter-RAT E-UTRAN capability for the inter-RAT E-UTRAN measurement without the gap and with an interruption.

In certain configurations, performing the UE behavior may include: reporting the UE capability supporting an effective measurement window (EMW), when the UE is unable to ensure absence of the scheduling restriction; and the EMW is configured for inter-RAT E-UTRAN capability for the inter-RAT E-UTRAN measurement without the gap and without an interruption. In these configurations, the UE may impose the scheduling restriction during the inter-RAT E-UTRAN measurement within the EMW. Alternatively, the UE may impose no scheduling restriction during the inter-RAT E-UTRAN measurement within the EMW.

Furthermore, in these configurations, the UE may recognize necessity of the scheduling restriction based on determination of the NW, when a condition set is met. For example, the condition set may include at least one of a condition related to scheduling availability of the UE that performs the inter-RAT E-UTRAN measurement with a different subcarrier spacing than a physical downlink shared channel or physical downlink control channel (PDSCH/PDCCH) on a frequency range FR1 but that does not support simultaneous reception with other subcarrier spacings; or a condition related to whether the UE supports a dual connectivity configuration information element simultaneousRxTxInterBandENDC for a band combination involving a band with serving cells of the UE and a target band to be measured.

In certain configurations, performing the UE behavior may include: reporting the UE capability supporting an effective measurement window (EMW), when the UE is unable to determine the necessity of the scheduling restriction and possesses the UE capability supporting the EMW; and the EMW is configured for inter-RAT E-UTRAN capability for the inter-RAT E-UTRAN measurement without the gap and with an interruption.

In certain configurations, performing the UE behavior may include: reporting the UE capability supporting an effective measurement window (EMW), when the UE is unable to determine the necessity of the scheduling restriction and possesses the UE capability supporting the EMW; and the EMW is configured for inter-RAT E-UTRAN capability for the inter-RAT E-UTRAN measurement without the gap and without an interruption. In these configurations, the UE may impose the scheduling restriction during the inter-RAT E-UTRAN measurement within the EMW. Alternatively, the UE may impose no scheduling restriction during the inter-RAT E-UTRAN measurement within the EMW.

Furthermore, in these configurations, the UE may recognize necessity of the scheduling restriction based on determination of the NW, when a condition set is met. For example, the condition set may include at least one of a condition related to scheduling availability of the UE that performs the inter-RAT E-UTRAN measurement with a different subcarrier spacing than a physical downlink shared channel or physical downlink control channel (PDSCH/PDCCH) on a frequency range FRI but that does not support simultaneous reception with other subcarrier spacings; or a condition related to whether the UE supports a dual connectivity configuration information element simultaneousRxTxInterBandENDC for a band combination involving a band with serving cells of the UE and a target band to be measured.

In certain configurations, the process may be applicable to a scenario of the inter-radio access technology (RAT) measurement without the gap and where a reference signal is located outside an active Downlink Bandwidth Part (DL BWP).

In certain configurations, the process may be applicable to a scenario of the inter-radio access technology (RAT) measurement without the gap where a cell-specific reference signals (CRS) is contained within an active Downlink Bandwidth Part (DL BWP) of the UE.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving, from a network (NW), a configuration for inter-radio access technology (RAT) measurement without a gap for a frequency band;
identifying a UE capability for supporting the configuration;
determining a UE behavior associated with scheduling restriction based on the UE capability; and
performing the UE behavior.

2. The method of claim 1, wherein the inter-RAT measurement comprises inter-RAT evolved universal terrestrial radio access network (E-UTRAN) measurement.

3. The method of claim 2, wherein determining the UE behavior associated with the scheduling restriction comprises:
determining necessity of the scheduling restriction.

4. The method of claim 3, further comprising:
determining the necessity of the scheduling restriction based on currently configured carrier aggregation (CA) band combination.

5. The method of claim 3, further comprising:
determining the necessity of the scheduling restriction based on a target inter-RAT E-UTRAN band to be measured.

6. The method of claim 3, wherein performing the UE behavior comprises:
reporting at least one of a network controlled small gap (NCSG) or a measurement gap, when the UE requires the scheduling restriction and the UE capability does not support an effective measurement window (EMW).

7. The method of claim 3, wherein performing the UE behavior comprises:
reporting the UE capability supporting an effective measurement window (EMW), when the UE is unable to ensure absence of the scheduling restriction; and
wherein the EMW is configured for inter-RAT E-UTRAN capability for the inter-RAT E-UTRAN measurement without the gap and with an interruption.

8. The method of claim 3, wherein performing the UE behavior comprises:
reporting the UE capability supporting an effective measurement window (EMW), when the UE is unable to ensure absence of the scheduling restriction; and
wherein the EMW is configured for inter-RAT E-UTRAN capability for the inter-RAT E-UTRAN measurement without the gap and without an interruption.

9. The method of claim 8, wherein the UE imposes the scheduling restriction during the inter-RAT E-UTRAN measurement within the EMW.

10. The method of claim 8, wherein the UE imposes no scheduling restriction during the inter-RAT E-UTRAN measurement within the EMW.

11. The method of claim 8, wherein the UE recognizes necessity of the scheduling restriction based on determination of the NW, when a condition set is met.

12. The method of claim 11, wherein the condition set comprises at least one of
a condition related to scheduling availability of the UE that performs the inter-RAT E-UTRAN measurement with a different subcarrier spacing than a physical downlink shared channel or physical downlink control channel (PDSCH/PDCCH) on a frequency range FR1 but that does not support simultaneous reception with other subcarrier spacings; or
a condition related to whether the UE supports a dual connectivity configuration information element simultaneousRxTxInterBandENDC for a band combination involving a band with serving cells of the UE and a target band to be measured.

13. The method of claim 3, wherein performing the UE behavior comprises:
reporting the UE capability supporting an effective measurement window (EMW), when the UE is unable to determine the necessity of the scheduling restriction and possesses the UE capability supporting the EMW; and
wherein the EMW is configured for inter-RAT E-UTRAN capability for the inter-RAT E-UTRAN measurement without the gap and with an interruption.

14. The method of claim 3, wherein performing the UE behavior comprises:
reporting the UE capability supporting an effective measurement window (EMW), when the UE is unable to determine the necessity of the scheduling restriction and possesses the UE capability supporting the EMW; and
wherein the EMW is configured for inter-RAT E-UTRAN capability for the inter-RAT E-UTRAN measurement without the gap and without an interruption.

15. The method of claim 14, wherein the UE imposes the scheduling restriction during the inter-RAT E-UTRAN measurement within the EMW.

16. The method of claim 14, wherein the UE imposes no scheduling restriction during the inter-RAT E-UTRAN measurement within the EMW.

17. The method of claim 14, wherein the UE recognizes necessity of the scheduling restriction based on determination of the NW, when a condition set is met.

18. The method of claim 17, wherein the condition set comprises at least one of
a condition related to scheduling availability of the UE that performs the inter-RAT E-UTRAN measurement with a different subcarrier spacing than a physical downlink shared channel or physical downlink control channel (PDSCH/PDCCH) on a frequency range FR1 but that does not support simultaneous reception with other subcarrier spacings; or
a condition related to whether the UE supports a dual connectivity configuration information element simultaneousRxTxInterBandENDC for a band combination involving a band with serving cells of the UE and a target band to be measured.

19. An apparatus for wireless communication, the apparatus being a user equipment (UE), comprising:
a memory; and
at least one processor coupled to the memory and configured to:
receive, from a network (NW), a configuration for inter-radio access technology (RAT) measurement without a gap for a frequency band;
identify a UE capability for supporting the configuration;
determine a UE behavior associated with scheduling restriction based on the UE capability; and
perform the UE behavior.

20. A computer-readable medium storing computer executable code for wireless communication of a user equipment (UE), comprising code to:
receive, from a network (NW), a configuration for inter-radio access technology (RAT) measurement without a gap for a frequency band;
identify a UE capability for supporting the configuration;
determine a UE behavior associated with scheduling restriction based on the UE capability; and
perform the UE behavior.
